(19) United States
(12) Patent Application Publication
(10) Pub. No.: US 2008/0172281 A1
(43) Pub. Date: Jul. 17, 2008

(54) Scheduling Service Based on Usage Data

(76) Inventor: David Malthe Probst, Copenhagen (DK)

Correspondence Address: MARSHALL, GERSTEIN & BORUN LLP (MICROSOFT), 233 SOUTH WACKER DRIVE, 6300 SEARS TOWER, CHICAGO, IL, 60606, US

(21) Appl. No.: 11/622,516

(22) Filed: Jan. 12, 2007

(51) Int. Cl. G06F 17/30

(52) U.S. Cl. 705/9; 705/8

(57) ABSTRACT

Usage data is compiled by a manufacture and may be used to note or predict the time for additional services and maintenance. Based on the prediction, additional actions may be taken, such as creating service requests, ordering parts needed for services, scheduling service providers and designing efficient service provider schedules.

### BACKGROUND

This Background is intended to provide the basic context of this patent application and is not intended to describe a specific problem to be solved.

In the past, maintenance and other services has been easy for users to ignore. At the same time, manufactures are not the end users and gathering usage and failure data has been a challenge. As computing methods have improved and been integrated into more devices, more and more usage data is available. In addition, communication methods have improved making the communication of the additional usage data easier and more cost effective. The question has become what to do with all the usage data to improve maintenance and avoid failures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Usage data is compiled by a manufacture and may be used to note or predict the time for additional services and maintenance. Limits may be set by a manufacturer and if the limits are pasted, additional services may be scheduled. In addition, the usage data may be used to predict when limits may be passed. Based on the prediction, additional actions may be taken, such as creating service requests, ordering parts needed for services, scheduling service providers and designing efficient service provider schedules.

### BRIEF DESCRIPTION OF THE FIGURES

FIG. 1 may be an illustration of a computer that implements the methods of scheduling service based on usage data; and

FIG. 2 may be an illustration of a method of scheduling service based on usage data.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

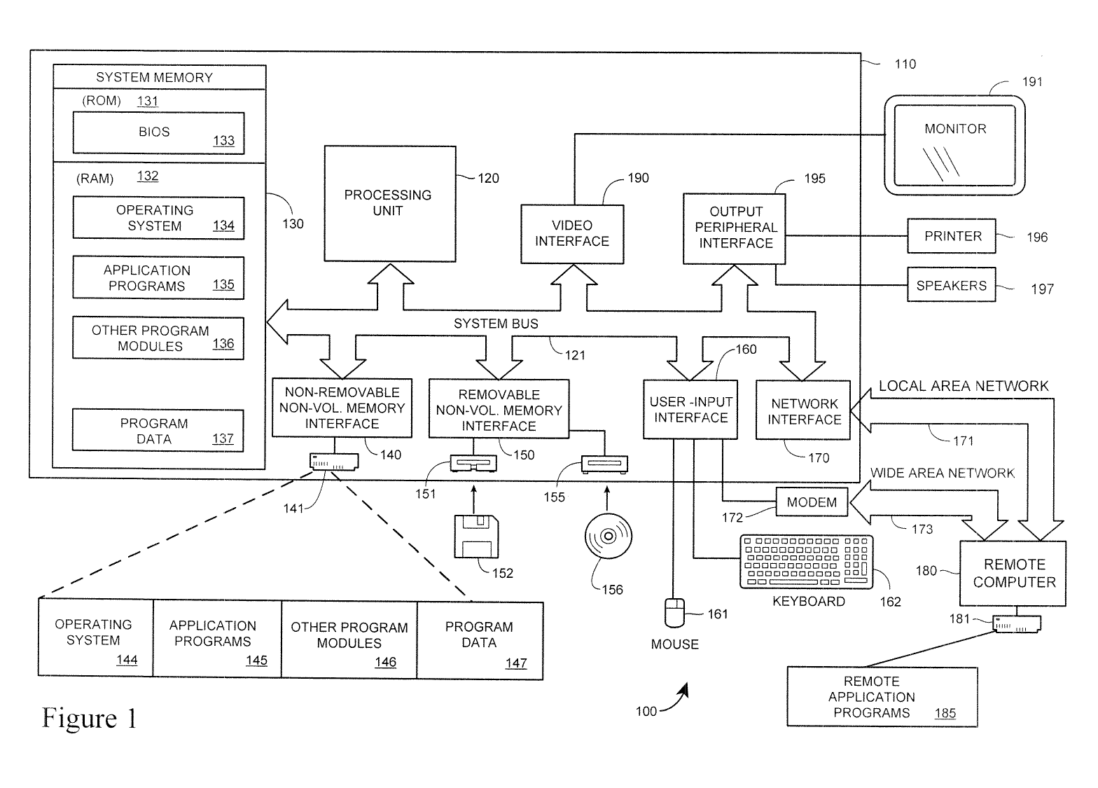

FIG. 1 illustrates an example of a suitable computing system environment 100 that may operate to display and provide the user interface described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 20 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor 191, computers may also include other peripheral output devices such as speakers 197 and printer 196, which may be connected through an output peripheral interface 190.

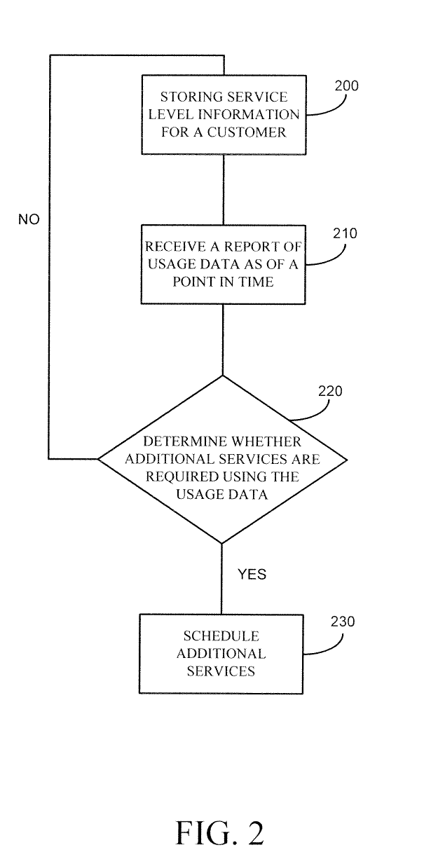

FIG. 2 may be an illustration of a method of scheduling service based on usage data. In many situations, a service agreement may exist between a seller and a user. As a result of the service agreement, the user may expect an item to be serviced at routine intervals such that catastrophic breakdowns are avoided. The item may have a meter that tracks usage or anomalies, including when there is a concentration of anomalies.

At block 200, service level information for a customer may be stored. The service level information may have a variety of embodiments. In some embodiments, the service level information may simply use limits, which if passed, would indicate that service is required. These limits may be either incrementally observable or when the item has reached a certain value by a decreasing value, for example, amount of a liquid used by the item etc. In other embodiments, the service level information may be maintenance agreements that describe various “if then” scenarios that would require action by the seller. Of course, additional service level information is possible reaching ever higher/lower values in a continued monitoring of a meter.

At block 210, a report of usage data as of a point in time may be received. The usage data may be any type that relates to the use of a good or service. In addition, the data may represent usage data from a plurality of sub-equipment in a larger piece of equipment. For example, the usage data may represent the number of times an elevator went up and down at a given point in time. In addition, the usage data may also represent the number of times the doors on the elevator open and closed, which may be a sub-system of the elevator as the doors may have different usage limits than the actual lifting mechanism. The data also may represent anomalies such as when the elevator doors were stuck.

At block 220, the usage data and the point in time from the usage data may be used to make a determination whether additional services are required. In one embodiment, the usage data is compared to limits set by the seller and the determination is based on whether the usage amount is beyond the limits. The limit may be preset or may be dynamic. For example, if the usage data shows a spike in use, even though the limit may not be exceeded, a service call may still be scheduled.

In one embodiment, a single set of readings from a single installation is compared to a single set of usage limits for that item or sub-equipment (1 to 1 or 1 to 1 calculation type). The determination is relatively straight forward: Is the usage amount greater than a usage limit? If the answer is yes, then additional actions need to be taken such as scheduling a maintenance visit. This same data may be used to predict the future usage at the single installation and may be used to predict future service needs. For example, if a usage limit has not been passed but it is clear from past usage that the limit will be passed very soon, the determination may be similar to a prediction that the limit will be passed and that in the near future, maintenance will need to be scheduled.

In another embodiment, the determination is more complex and involves using additional usage data to predict the future usage. In another embodiment, data from one installation is used to predict the maintenance needs of many installations (1 to many). This may be based on previous experience, trial and error or on similarity of installation and equipment.

In yet another embodiment, the data from many installations is used to predict the future maintenance needs of a single installation (many to 1). The many installations may be similar in a variety of characteristic such as the usage level, the equipment, the sub-equipment, past repair history, or other logical reason. Of course, data from many installations may be used to predict the future maintenance needs of many installations (many to many).

The prediction may be made using a variety of different methods. Some method may include Linear Least Squares, Simple Moving Average, Weighted Moving Average and Exponential Moving Average. Other methods are possible and would work. In addition, if the data collected from a single or multiple installations shows seasonal variance, asymptomatic or exponential behavior, the collected data could be used to find the optimal time of future service requests.

In more detail, the above formulas essentially end up giving two values the a and b in the linear formula of y=ax+b. In an example where meter reading are used to determine the need for additional services, this means that the method may find the meter reading limit or budget lines which are the values on the Y axis and locate the date this meter budget or limit is met.

For example, using the calculation type of 1 set of readings to 1 set of limits, a set of meter readings gives an a of 10, essentially meaning that the method expects an additional 10 meter “counts” to be performed every day. The meter budget or limit may be found by inserting these values as Y. If the date where the meter reading read 0 (Y=0) is November 1st and the meter budget contains two values of 100 and 200 then these values may be met November 11th and 21st. The formulas above can be used together with the calculation Methods of 1 to 1 (reading to installation limit), 1 To Many and Many To 1 described above.

In the case of a 1 to Many Calculation type, the date which the single original meter reading set of data was starting from 0, can not be used on the set of resulting meter budgets. What may be useful is the gradient which is used on the last meter reading on the result set. If the result set consists of two installations where one installations last reading reads 100 and the other reads 200 on November 1st, both installations have a meter budget line of 250 then the first installation will meet that budget line at the 16th (a=10) and the second will meet the budget at November 6th. If either installation did not have any meter readings, then a warning would inform the user that this installation was not calculated.

In the case of a many to 1 Calculation type, the method may be actually finding a set of gradients, and these gradients may be averaged to be used on the resulting single data set. Again, the intersection is not used, and a single meter reading is required for the calculation. The single meter reading could be the date of implementation where the expected meter reading would read 0 (zero).

The Simple Moving Average takes a set of meter readings and finds the average. The value found is not actually the reading itself but the delta between two sets of readings divided by the number of days between the two sets of readings. If for example a set of Meter reading is extracted from the “Data from” field group which look like this:

| Value | Date |
|---|---|
| 105 | 01-nov-06 |
| 286 | 03-nov-06 |
| 388 | 04-nov-06 |
| 668 | 07-nov-06 |
| 767 | 08-nov-06 |
| 959 | 10-nov-06 |

The SMA will split these into intervals finding the delta for each day:

| Delta | Value |
|---|---|
| 1–2 | 90.50 |
| 2–3 | 90.50 |
| 3–4 | 102.00 |
| 4–5 | 93.33 |
| 5–6 | 93.33 |
| 6–7 | 93.33 |
| 7–8 | 99.00 |
| 8–9 | 96.00 |
| 9–10 | 96.00 |

Next, the method iterates through these values finding the average for the entire set so that November 11th has a value of the sum of all the above values divided by 9 (94.89) in order to find the value for November 12th and all the values between November 2nd until November 11th is summed and again divided by 9, and so on. Notice that the oldest value keeps dropping out making it possible to do this in an array, for example.

The Weighted Moving Average method takes again the same set of data, by defining a date interval as the above we get a weight set of 9 to 1 which is multiplied with each delta:

| Delta | Value | Weight | Sum |
|---|---|---|---|
| 1–2 | 90.50 | 1 | 90.50 |
| 2–3 | 90.50 | 2 | 181.00 |
| 3–4 | 102.00 | 3 | 306.00 |
| 4–5 | 93.33 | 4 | 373.33 |
| 5–6 | 93.33 | 5 | 466.67 |
| 6–7 | 93.33 | 6 | 560.00 |
| 7–8 | 99.00 | 7 | 693.00 |
| 8–9 | 96.00 | 8 | 768.00 |
| 9–10 | 96.00 | 9 | 864.00 |

In order to find the expected delta for the interval between 10 and 11, the method may sum the sums and divide them by the sum of weights (1+2+3 . . . +9=45) to get the value 95.61. In order to find the delta between 11 and 12, the method may use the found value (95.61) with a multiplying factor of 9 while the delta 1-2 is disregarded.

The Exponential Moving Average takes in a value between 0 and 1 (where neither 0 nor 1 is allowed). If a user for example enters a value of 0.2 and the method reuses the above data set, the values are entered into this formula:

$$EMA = \frac{{p}_{1} + ( 1 - α ) {p}_{2} + {( 1 - α )}^{2} {p}_{3} + {( 1 - α )}^{3} {p}_{4} + ⋯}{1 + ( 1 - α ) + {( 1 - α )}^{2} + {( 1 - α )}^{3} + ⋯}$$

This gives a data set with a value of 0.2:

| Delta | Value | Weight | Value * Weight |
|---|---|---|---|
| 1–2 | 90.50 | 0.134 | 12.1467 |
| 2–3 | 90.50 | 0.168 | 15.18338 |
| 3–4 | 102.00 | 0.210 | 21.39095 |
| 4–5 | 93.33 | 0.262 | 24.46677 |
| 5–6 | 93.33 | 0.328 | 30.58347 |
| 6–7 | 93.33 | 0.410 | 38.22933 |
| 7–8 | 99.00 | 0.512 | 50.688 |
| 8–9 | 96.00 | 0.640 | 61.44 |
| 9–10 | 96.00 | 0.800 | 76.8 |

Where the sum of Value*weight divided by the sum of weight gives the interval for the delta between 10 and 11 (330.93/3.46=95.56). The delta between 11 and 12 is found by multiplying the previous found value with 0.8 while the remaining values are moved down the list.

Referring again back to block 220, the usage data from the plurality of sub-equipment may also be used to determine whether additional services are required. For example, in the elevator example, the number of times a door on an elevator opens and closes may be used to determine whether additional services may be needed for the lift mechanism itself as the door usage may have a high correlation with wear on the lift mechanism. Similar to the methods described above, the data from one subsystem may be used to determine the service needs for one installation or many installations. Similarly, the data from many subsystems may be used to predict the usage level of one installation or many installations.

At block 230, the provision of the additional services based on the determination of whether additional services are required may be scheduled. The additional services may be maintenance related or may be other services. In addition, more than just additional services may be scheduled. For example if additional maintenance is required, then parts often are required. In one embodiment, the method may check to see if the parts are in inventory. If the parts are not in inventory, the method may schedule the purchase of the parts such that the parts will be in inventory at the time the service is scheduled. In another embodiment, service personnel skill and availability may be evaluated in scheduling the provision of the additional services. In yet another embodiment, the location of the scheduled installation visits may be analyzed and a travel schedule may be created to bunch trips to similar destinations together. In yet another embodiment, the method may create the service order to perform the additional services.

The method or embodiments of the method may be part of an enterprise resource planning (“ERP”) system. The relevant data about the meter readings, the limits or levels, the service agreement, the method of predicting future usage, inventory handling etc. may all be part of the ERP system. For example, a user may be able to select the method of predicting future usage. As another example, the service agreement may be loaded into the ERP system such that the agreements may be reviewed to determine the services that are contractually required, invoices handled etc. Further, the various limits or levels may be part of the ERP system.

In addition, the ERP system may have access to usage data from a wide variety of customers. This data can be used to make better predictions of for use and future problems along with identifying issues quickly. For example, if an update to software is distributed and many anomalies are received from many customers, it would make logical sense to assume there is a problem with the software update that needs to be quickly addressed.

The ERP system may have access to the parts in inventory, the technicians, the skill set of the technicians, the availability of the technicians, location of the customers, preferred times for services, personnel to contact, etc. As a result, much of the method may be automatic once it is set up. For example, some ERP systems have employee scheduling modules and these modules may be used to evaluate worker skills and customer needs, including needs in the future, and create an optimal solution of workers and customer needs.

The ERP system may also have access to relevant customer data. For example, the ERP system may have information on the proper contact person at a customer to schedule service. In one embodiment, the ERP system may communicate with the contact person that service is required. In some embodiments, the ERP system may have access to the schedule of the contact person such that the service may be scheduled at a time when the contact person is available. Similarity of received usage data could be dependent on customer data stored in the ERP system, examples could be geographic, revenue or number of employees.

1. A method of providing additional services based on previous usage comprising:
storing service level information for a customer;
receiving a report of usage data as of a point in time for the customer;
using the usage data and the service level information to make a determination whether additional services are required for the customer; and
scheduling the provision of the additional services for the customer based on the determination of whether additional services are required.

2. The method of claim 1, wherein using the usage data to make a determination whether additional services are required further comprises determining whether a usage level has passed a predetermined level.

3. The method of claim 1, wherein using the usage data to make a determination whether additional services are required further comprises using previous dates and usage levels make a prediction when additional services will be required.

4. The method of claim 3, wherein the prediction is made using one method selected from the group comprising:
Linear Least Squares;
Simple Moving Average;
Weighted Moving Average; and
Exponential Moving Average.

5. The method of claim 1, wherein the usage data represents usage data from a plurality of sub-equipment in a larger piece of equipment and the usage data from the plurality of sub-equipment is used to determine whether additional services are required.

6. The method of claim 5, wherein the usage data from the plurality of sub-equipment is used to determine when sub-equipment in a larger piece of equipment needs additional service and when the larger piece of equipment needs additional service.

7. The method of claim 6, further comprising determining the additional services that are needed.

8. The method of claim 7, further comprising ordering parts that are necessary to provide the additional services in time to meet the scheduled time to provide additional services.

9. The method of claim 7, further comprising evaluating service personnel skill and availability in scheduling the provision of the additional services.

10. The method of claim 1, further comprising creating the service order to perform the additional services.

11. The method of claim 3, further comprising based on the predicted need for additional services, at least one of the group comprising:
scheduling the provision of the additional services;
ordering parts that are necessary to provide the additional services in time to meet the scheduled time to provide additional services;
evaluating service personnel skill and availability in scheduling the provision of the additional services; and
creating the service order to perform the additional services.

12. The method of claim 1, wherein the service level information further comprises a service agreement.

13. The method of claim 1, wherein the method is part of an enterprise resource planning (ERP) system and the ERP system stores the usage data, makes the determination whether additional services are required and schedules the additional services if the determination is that additional services are needed.

14. An enterprise resource program planning physically embodied on a computer readable medium, the enterprise resource program comprising computer executable instructions for:
storing service level information for a customer;
receiving a report of usage data as of a point in time for the customer;
using the usage data and the service level information to make a determination whether additional services are required for the customer; and
scheduling the provision of the additional services for the customer based on the determination of whether additional services are required.

15. The enterprise resource program planning of claim 14, wherein using the usage data to make a determination whether additional services are required further comprises using previous dates and usage levels make a prediction when additional services will be required and the prediction is made using a method selected from the group comprising:
Linear Least Squares;
Simple Moving Average;
Weighted Moving Average; and
Exponential Moving Average.

16. The enterprise resource program planning of claim 14, further comprising computer executable instructions for performing, based on the predicted need for additional services, at least one of the group comprising:
scheduling the provision of the additional services;
ordering parts that are necessary to provide the additional services in time to meet the scheduled time to provide additional services;
evaluating service personnel skill and availability in scheduling the provision of the additional services; and
creating the service order to perform the additional services.

17. The enterprise resource program of claim 14, wherein the service level information comprises a service agreement.

18. A computer system comprising a processor for executing computer executable code a memory for storing data and computer executable code and an input/output circuit, the processor physically configure to execute computer executable code for:
storing service level information for a customer;
receiving a report of usage data as of a point in time for the customer;
using the usage data and the service level information to make a determination whether additional services are required for the customer; and
scheduling the provision of the additional services for the customer based on the determination of whether additional services are required.

19. The computer system of claim 18, wherein using the usage data to make a determination whether additional services are required further comprises using previous dates and usage levels make a prediction when additional services will be required and the prediction is made using one a method selected from a group comprising:
Linear Least Squares;
Simple Moving Average;
Weighted Moving Average; and
Exponential Moving Average.

20. The computer system of claim 18 further comprising computer executable instructions for performing, based on the predicted need for additional services, at least one of a group comprising:
scheduling the provision of the additional services;
ordering parts that are necessary to provide the additional services in time to meet the scheduled time to provide additional services;
evaluating service personnel skill and availability in scheduling the provision of the additional services; and
creating the service order to perform the additional services.
